(19) United States
(12) Patent Application Publication
(10) Pub. No.: US 2008/0041981 A1
(43) Pub. Date: Feb. 21, 2008

(54) Solid waste treatment apparatus and method

(76) Inventor: Roy Lee Garrison, Pensacola, FL (US)

Correspondence Address: J. Nevin Shaffer, Jr. P.A., Suite 43, 913 Gulf Breeze Parkway, Gulf Breeze, FL, 32561, US

(21) Appl. No.: 11/490,766

(22) Filed: Jul. 21, 2006

(51) Int. Cl. B02C 21/00

(52) U.S. Cl. 241/18

(57) ABSTRACT

A solid waste treatment apparatus and method includes a process vessel with an exterior and an interior. Outlets are provided in the process vessel for introducing gas into the interior from the exterior through the outlets where the outlets are adjustable such that gas may be directed toward a location of the interior of the process vessel. Further, a load sensor is coupled to the process vessel for automatically sensing capacity of the process vessel as the process vessel is loaded with solid waste.

### FIELD OF THE INVENTION

This invention relates to a solid waste treatment apparatus and method. In particular, in accordance with one embodiment, the invention relates to a solid waste treatment apparatus including a process vessel with an exterior and an interior. Outlets are provided in the process vessel for introducing gas into the interior from the exterior through the outlets where the outlets are adjustable such that gas may be directed toward a single end of the interior of the process vessel. A load sensor is attached to the process vessel for automatically sensing capacity of the process vessel as the process vessel is loaded with solid waste.

### BACKGROUND OF THE INVENTION

A continuing challenge and an ever growing problem in the world is the solid waste generated by its inhabitants. As the population has grown, previous “solutions” to the problem of how to responsibly dispose of solid waste have become outdated and dangerous to society. Large deposits of solid wastes dot the landscape of every country in the world. These prior art solutions to the problem of solid waste disposal have in turn become a huge problem for society. These sites are guaranteed to leak and to contaminate the surrounding area with toxic runoff both above and below the ground. And, contrary to early beliefs, buried solid waste does not decompose. It simply sits there and becomes more toxic as time goes by but it does not disappear. In short, the problem is that waste generated by an industrialized society that is buried creates an extraordinary risk to the fresh water supply and general health for many hundreds if not thousands of years because of the many complex contaminants that are contained in the waste that do not biodegrade naturally. Lining waste pits with plastic liners only postpones the leak of contaminants until the plastic fails as it will inevitably do.

Several prior art solutions are known to the Applicant that represented improvements on means and methods for handling so called municipal solid waste or “MSW”. Applicant was a co-inventor of the original application for a patent that issued to Malley as U.S. Pat. No. 6,397,492. This invention was granted for the reason that the known prior art did not teach a method and apparatus for processing solid waste products containing pulp and paper in which steam discharged from a processing vessel is monitored and the flow of steam into the vessel is regulated such that the temperature of the discharged steam and the internal pressure of the vessel stay within a predetermined processing range. Malley discloses a two door device that includes helical flighting attached to the inside walls of the vessel for conveying waste products longitudinally within the vessel and steam lines that also extend along the interior of the vessel. Both the flighting and steam lines reduce the useful treatment volume of the process vessel, add weight, complexity and cost to the device and place it at risk for mechanical breakdowns, and reduce the ability of the process vessel to be easily emptied by simply tipping the vessel since material hangs up on these interior structures forcing the vessel to be rotated in order to move the processed material out of the vessel.

Eley, U.S. Pat. No. 6,306,248 is also familiar to the Applicant and representative of the current art in the field of this invention. Eley discloses a one door device otherwise similar to Malley including interior steam lines and helical flighting. The Eley method requires adding steam at sufficient temperature and pressure to expand the molecular structure of the solid waste products. Eley discloses that temperature in the range of about 287 Degrees F. to 312 Degrees F. at a pressure of about 40 psig to about 65 psig is useful to his invention. Again, both the flighting and steam lines reduce the useful treatment volume of the process vessel, add weight, complexity and cost to the device and place it at risk for mechanical breakdowns, and reduce the ability of the process vessel to be easily emptied by simply tipping the vessel since material hangs up on these interior structures forcing the vessel to be rotated in order to move the processed material out of the vessel.

Applicant is especially aware of the failings of the prior art as indicated by way of example above. All of the prior art devices and methods known to Applicant have no solution to the problem of how much MSW is actually added to a treatment vessel and how long to treat the MSW once loaded to ensure that the MSW that actually has been loaded is effectively treated. MSW is not a homogenous mass. It includes everything that was yesterday's useful material. It includes baby diapers, batteries, bottles, papers and the like. Thus, a major problem facing attempts to treat MSW is the MSW itself. Whatever is introduced into a treatment vessel is guaranteed to include a variety of materials both liquid and solid. Eley discloses filling the vessel with a predetermined weight of MSW but does not disclose or suggest any manner for determining what amount of MSW is actually loaded into the vessel by the Eley conveyor system. Apparently a predetermined weight of MSW is placed on the conveyor and the conveyor is operated to load the vessel. Obviously, what amount of the MSW, some of which is in liquid form, survives the trip on the conveyor into the vessel can never be known. Malley states that the fact that the Malley vessel is preheated and that steam is continuously introduced into the vessel during loading which causes the MSW to break down during loading results in material of roughly uniform density so that, according to Malley, the same mass of MSW is processed in each batch. What amount of MSW is actually in the Malley vessel at the time treatment begins is unknown. That is, Malley introduces MSW into the vessel until it falls out of the opening but never measures what amount actually makes it into the vessel for treatment.

Even more importantly, neither Eley nor Malley disclose or suggest any way to determine just when the MSW has been fully treated so as to know exactly when to stop their treatment of the MSW. The best they can offer, essentially, is a circular answer that their treatment is done when it is done. The focus of these and other devices is on applying temperature and pressure for an arbitrary range of time so as to treat MSW within particularly prescribed pressure and temperature ranges. Eley says to treat the MSW for from at least 30 minutes up to a maximum of one hour at between 45 to 65 psig and from about 287 Degrees F. to about 312 Degrees F. Malley discloses “processing ranges” of around 50 psi and 300 Degrees F. for from 25 to 50 minutes. Malley acknowledges that MSW batches will still vary and Malley discloses the requirement, therefore, of constantly monitoring the output temperature and constantly adjusting the flow of steam through the device during his process. In either case, after these two processes have been operated for what they claim to be the essentially identical effective times, the MSW in the vessel is deemed treated whether or not it actually has been. Neither discloses or suggests any means or method to determine whether or not a particular “batch” of MSW has in fact been completely treated at the end of the treatment processes other than dumping the MSW out and examining it.

Thus there is a need in the art for an apparatus and method for treating MSW that is economical, that uses a mechanically sound process vessel with few moving or attached internal parts, that enables a user to determine what amount of MSW has actually been loaded in the process vessel and when a particular batch of MSW has in fact been fully treated without stopping the vessel and looking at the MSW. It, therefore, is an object of this invention to provide an economical, environmentally friendly, MSW apparatus and method that is mechanically robust and which produces predictable treated MSW known to be treated as required.

### SUMMARY OF THE INVENTION

Accordingly, the waste treatment apparatus and method of the present invention includes, according to one embodiment, a solid waste treatment apparatus and method with a process vessel with an exterior and an interior. Outlets are provided in the process vessel for introducing gas into the interior from the exterior through the outlets where the outlets are adjustable such that gas may be directed toward a location of the interior of the process vessel. In a further aspect, a load sensor is coupled to the process vessel for automatically sensing capacity of the process vessel as the process vessel is loaded with solid waste.

According to another embodiment of the invention, the waste treatment apparatus and method of the present invention includes a double hull process vessel where the double hull process vessel includes an exterior vessel and an interior vessel. A space is provided between the exterior vessel and the interior vessel for receiving gas into the exterior vessel. Outlets are provided in the interior vessel such that the gas in the space is introduced to the interior vessel from the exterior vessel through the outlets. And a load sensor is coupled to the double hull process vessel for automatically sensing capacity of the double hull process vessel as the double hull process vessel is loaded with solid waste.

According to another aspect of several embodiments of the invention, the load sensor senses impacting vibrations of the solid waste within the double hull process vessel as the double hull process vessel is rotated. In another aspect, the double hull process vessel is rotated and the load sensor controls how fast the double hull process vessel is rotated. In another aspect, the load sensor controls how much gas is introduced into the space. According to another aspect, the load sensor senses rotational thrust signatures and falling load impact signatures when the double hull process vessel is rotated. In a further aspect, the outlets are angled such that gas is introduced into the interior vessel and is directed toward a location of the interior vessel.

According to another embodiment of the invention, a solid waste treatment apparatus includes a double hull process vessel with a loading door where the double hull process vessel includes an exterior vessel and an interior vessel. A space is provided between the exterior vessel and the interior vessel for receiving steam into the exterior vessel. Outlets are provided in the interior vessel such that the steam in the space is introduced to the interior vessel from the exterior vessel through the outlets and where the outlets are angled such that steam is introduced into the interior vessel toward a location. And a load sensor is coupled to the double hull process vessel for automatically sensing capacity of the double hull process vessel as the double hull process vessel is loaded with solid waste and where the load sensor senses impacting vibrations of the solid waste within the double hull process vessel as the double hull process vessel is rotated.

According to another aspect of several embodiments of the invention, the load sensor controls how fast the double hull process vessel is rotated. In another aspect, the load sensor controls how much steam is introduced into the space. In a further aspect, the load sensor senses rotational thrust signatures and falling load impact signatures as the double hull process vessel is rotated. In another aspect, a lift for raising and lowering the double hull process vessel is provided.

According to another aspect, a high speed loader is provided for loading solid waste into the apparatus at high speed. In a further aspect, a magnetic emission treatment device is provided for treating emissions from the double hull process vessel. In another aspect, a closeable floor pit is provided into which treated solid waste is deposited after treatment in the double hull process vessel.

According to another embodiment, a solid waste treatment method includes: providing a double hull process vessel with a loading door where the double hull process vessel includes an exterior vessel and an interior vessel and a space is maintained between the exterior vessel and the interior vessel for receiving steam into the exterior vessel and outlets in the interior vessel are provided such that steam introduced into the space is introduced to the interior vessel from the exterior vessel through the outlets and where the outlets are angled such that steam is introduced into the interior vessel toward a location and where a load sensor is coupled to the double hull process vessel for automatically sensing capacity of the double hull process vessel as the double hull process vessel is loaded with solid waste and where the load sensor senses impacting vibrations of the solid waste within the double hull process vessel as the double hull process vessel is rotated; loading solid waste into the double hull process vessel until the load sensor indicates capacity has been reached; rotating the double hull process vessel and adding steam until the load sensor indicates that a maximum load density has been reached; and emptying the double hull process vessel.

According to another aspect of several embodiments, the load sensor senses rotational thrust signatures and falling load impact signatures as the double hull process vessel is rotated. According to a further aspect, a lift is provided for raising and lowering the double hull process vessel. In a further aspect, emissions from the double hull process vessel are treated with a magnetic emission treatment device. In another aspect, a closeable floor pit is provided into which treated solid waste is deposited after treatment in the double hull process vessel.

### DESCRIPTION OF THE DRAWINGS

Other objects, features and advantages of the present invention will become more fully apparent from the following detailed description of the preferred embodiment, the appended claims and the accompanying drawings in which:

FIG. 1 is a side sectional view of the treatment apparatus of the present invention according to one embodiment where adjustable outlets enable a user to control the direction the outlet is pointed within a process vessel;

FIG. 2 is a side sectional view of a treatment apparatus according to another embodiment of the invention showing a double hull process vessel with an exterior hull and an interior hull with angled outlets in the interior hull;

FIG. 3 is a side view of the apparatus of FIG. 1 or 2 showing the process vessel in a raised position;

FIG. 4 is a side view of the apparatus of FIG. 1 or 2 showing the process vessel in a lowered position for dumping processed MSW into a closeable pit; and

FIG. 5 is a diagram of the flow of MSW according to the present invention from untreated MSW entering the system to treated MSW leaving the system

### DETAILED DESCRIPTION OF THE INVENTION

Preferred embodiments of the present invention are illustrated by way of example in FIGS. 1-5. With specific reference to FIG. 1, a solid waste treatment apparatus, according to one embodiment, includes a process vessel 12. Process vessel 12 includes an exterior 14 that creates an interior treatment space 16 and at least one loading door 18. Exterior 14 may be made of steel or any other metal or material capable of withstanding extreme temperature and pressure changes, all as known in the art. The thickness of exterior 14 and the dimensions of process vessel 12 are any dimensions deemed useful and may be empirically determined by those of ordinary skill depending on the exact requirements of a particular waste treatment system. Likewise loading door 18 may be any shape or dimension useful for moveably sealing the process vessel 12. Loading door 18 forms a complete pressure and temperature containment of process vessel 12 when in the closed position as illustrated in FIG. 1. Loading door 18 may be hinged or removable, as desired and known.

Thus, the loading and unloading door 18 may be round with its sealing surfaces attached outside the vessel 12 outer wall 14 in order to allow for a smooth transfer of materials entering and exiting the vessel 12 without ridges and obstruction areas creating surface resistance. Further, the door 18 and vessel 12 assembly is at a dimension determined to be equal to each other ranging, for example only, from a door 18 of less than three feet in diameter with twenty feet of vessel 12 length (useful for testing and lab research) and up to a door 18 of twelve feet in diameter and a vessel 12 of eighty feet in length for full scale industrial operations. It is noted, again, that any dimension or variation of diameter and length can effectively process MSW materials with this invention process control methodology.

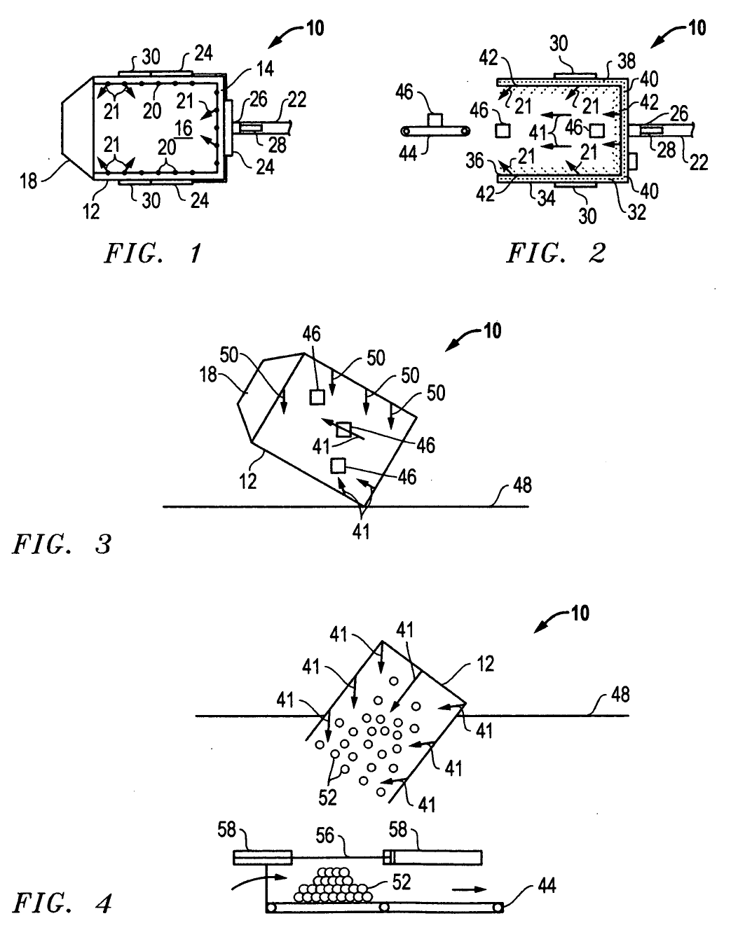

Importantly, process vessel 12 includes outlets 20 for the introduction of gas into the process vessel 12. According to one embodiment (See FIG. 2) outlets 20 are created in the process vessel 12 so that gas is introduced at a predetermined angle in the direction of direction arrows 21, for example only and not by way of limitation and as will be discussed more fully hereafter. According to one embodiment, the effect of the angle in the outlets 20 is to move material within the process vessel 12 in a particular direction, as will be discussed more fully hereafter. FIG. 1 illustrates another embodiment of the invention wherein outlets 20 are adjustable outlets 20 that may be automatically moved to point in any desired direction as indicated by direction arrows 21. For example, in this embodiment, the outlets 20 are directionally adjustable. Preferably, adjustable outlets 20 may all be directed toward a single end of process vessel 12, such as the end of process vessel 12 that includes loading door 18. Adjustable outlets 20 enable a user to move MSW as desired in the direction of direction arrows 21 and/or as needed without the requirements of the prior art helical flights or any other devices attached to the interior treatment space 16, as will be discussed more fully hereafter. In one form, adjustable outlets 20 are metal nozzles, preferably, that are capable of withstanding high temperatures and pressures, all as known in the art. Further, adjustable outlets 20 are remotely adjustable by any means now known or hereafter developed, such as by electrical mechanical servomechanisms all well within ordinary skill levels of those in the art. Adjustable outlets 20 enable high pressure and high temperature gas, such as steam for example, to contact MSW within vessel 12 at all angles. Whichever embodiment is used, outlets 20 allow the interior treatment space 16 of process vessel 12 to be clean, smooth and uncluttered. This allows more waste to be treated in a process vessel 12 than a similarly sized process vessel of any known prior art configuration where the interior also includes steam lines and helical vanes. The clean, smooth interior treatment space 16 also enables treated waste to be easily and completely emptied once treated because there are no interior lines and devices upon which the waste can collect or hang up.

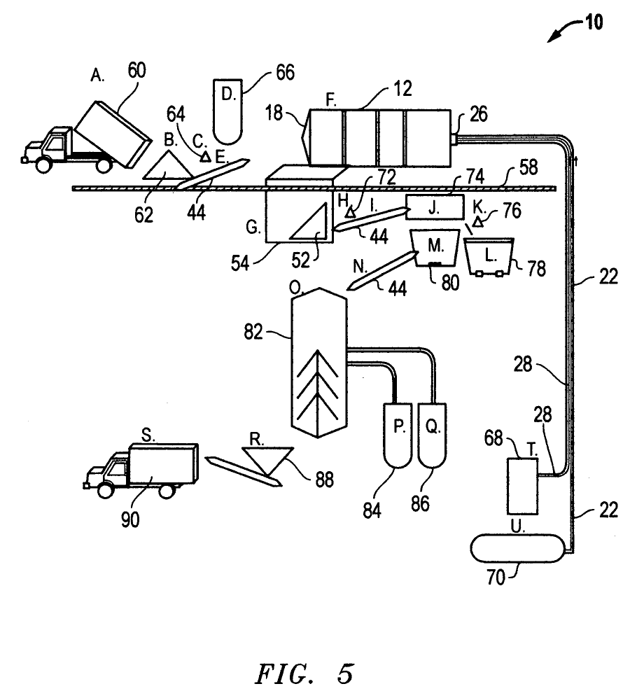

FIG. 1 also illustrates steam connection 22 and steam manifold 24 for directing steam to adjustable outlets 20. Steam connection 22 is connected to a source of steam, not shown, and is connected to steam manifold 24 by a rotating connection 26, as is known in the art, such that steam connection 22 to steam manifold 24 is maintained when process vessel 12 is rotated as discussed more fully hereafter. FIG. 1 also illustrates a steam exhaust line 28 through which steam exhaust and other emissions created during the treatment process are discharged. Steam exhaust line 28 surrounds steam connection line 22 and is preferably connected to an exhaust treatment device 68 for treatment as will be discussed more fully hereafter with regard to FIG. 5.

It should be understood that steam is the preferred gas for use in Applicant's solid waste treatment apparatus and method 10 but steam may be replaced with any gas now known or hereafter developed for the treatment of solid waste.

FIG. 1 also shows load sensor 30 attached to process vessel 12. Load sensor 30 is any load sensor now known or hereafter developed for sensing loads. In use, load sensor 30 indicates to a user when interior treatment space 16 has reached a predetermined capacity such as a “maximum capacity” by weight for a particular process vessel 12. Maximum capacity is determined empirically depending on the actual dimensions of process vessel 12. In it simplest form, load sensor 30 measures the load difference between process vessel 12 prior to the start of the loading of MSW into interior treatment space 16 and tracks the increase of weight as loading progresses. Again, once the maximum treatment capacity by weight of a particular process vessel 12 is reached this state is indicated to the user by any means known in the art including a digital display on an operator's panel (not shown). In the case where the maximum capacity by volume of a particular process vessel 12 is reached before the maximum capacity by weight is reached, loading is simply stopped and the actual weight of the MSW loaded in process vessel 12 to be treated is determined. This is a particular advantage of several embodiments of Applicant's invention over the prior art. That is, in the prior art, the only measurement of the MSW to be treated occurs before it is loaded into the process vessel. Should the vessel become full by volume before the predetermined amount of MSW is loaded, no accurate way to measure the amount actually loaded is provided in the prior art. Again according to several embodiments of Applicant's invention, process vessel 12 is simply loaded with MSW and when the maximum capacity by weight or volume is reached, loading is stopped. The actual amount of MSW to be treated is determined by the weight of the MSW in the process vessel after loading is stopped.

Referring now to FIG. 2, another embodiment of the solid waste treatment apparatus 10 is disclosed in which process vessel 12 is a double hull process vessel 32 with an exterior vessel 34 and an interior vessel 36. Space 38 is created between exterior vessel 34 and interior vessel 36 into which gas 40, such as steam, is introduced by means of steam connection 22 which is connected to exterior vessel 34 through rotating connection 26 as illustrated. Outlets 42 connect space 38 to interior treatment space 16 through interior vessel 36. Outlets 42, according to this embodiment, are cut outs in the thickness of the interior vessel 36 that are directed to and/or angled, for example only, toward one end of the process vessel 12, preferably, the end of process vessel 12 with loading door 18. That is, cuts outs 42 are angled to direct steam 40, and hence the MSW being treated, toward the loading door 18 preferably. Thus, as with adjustable outlets 20, totally eliminating the need and expense of any interior flighting or steam sparging lines as is required in the prior art.

As shown in the figure, the outlets 42 in the end of process vessel 12 are pointed directly at loading door 18 or are slightly angled away from the edges of the process vessel 12 toward the center line of process vessel 12 and loading door 18 too. This alignment, of outlets 42, acts upon MSW within process vessel 12 to treat the MSW as will be discussed more fully hereafter and to direct the MSW in the direction of direction arrows 41 toward loading door 18 without the need of adding expensive flighting to the interior vessel 36. Thus, according to this embodiment, outlets 42 are not movable as are adjustable outlets 20 described above. These outlets 42 are therefore not subject to mechanical breakdown as they include no movable parts. Obviously, however, outlets 42 may be adjustable too if desired.

FIG. 2 is shown with loading door 18 open and/or removed. FIG. 2 illustrates another feature of several embodiments of the invention whereby a conveyor belt 44, as is known in the art, operates at high speed to throw MSW 46 into the interior treatment space 16 of process vessel 12. Process vessel 12 may be rotating or stationary while MSW 46 is loaded. As shown, by operating conveyor belt 42 at high speed, MSW 46 naturally separates itself with the heavier MSW 46 farther away from the loading door 18 than lighter MSW 46. Accordingly, MSW 46 will be deposited in a practically solid mass from the rear of process vessel 12 to the front of the process vessel 12 and MSW 46 will not simply be piled up at the loading door 18.

Referring now to FIGS. 3 and 4, another feature of some embodiments of the invention is disclosed where process vessel 12 is movable from a raised position above level 48 as shown in FIG. 3 to a lowered position below level 48 as shown in FIG. 4. FIGS. 3 and 4 also show the advantage of the directional adjustable outlets 20 and/or the angled outlets 42 when directed toward loading door 18. In FIG. 3, as the MSW 46 falls in the direction of arrows 51 steam in the direction of arrows 41 cuts though MSW 46 and processes it as will be discussed more fully hereafter. Process vessel 12 may be lowered and raised as desired throughout the treatment process to ensure that the MSW 46 is completely and effectively treated. Machinery to raise and lower process vessel 12 includes a motor and supports (not shown) all well within ordinary skill and the proper motor and supports may be empirically determined based upon the actual process vessel 12 dimensions.

FIG. 4 shows that directional adjustable outlets 20 and/or the angled outlets 42 are all that is necessary to direct treated MSW 52 out of the interior treatment space 16. FIG. 4 shows another feature of some embodiments of the invention where a pit 54 covered by a closeable floor door 56 is provided in the floor 58 of the treatment facility. Once treatment is completed, closeable floor door 56 is opened, and treated MSW 52 is dumped into pit 54. Preferably, pit 54 includes a conveyor system 44 for use in directing the treated MSW 52 through the remaining treatment process as discussed with regard to FIG. 5. Once treated MSW 52 is emptied into pit 54, closeable floor door 56 is closed, process vessel is returned to the loading position shown in FIG. 2 and more untreated MSW 46 is loaded for treatment.

Referring now to FIG. 5, the solid waste treatment apparatus and method 10 according to several embodiments of the present invention is disclosed from the introduction of untreated MSW 46 into the process until the off loading of treated MSW 52. Applicant's process begins at step A where a waste truck 60, loaded with untreated MSW 46, unloads the untreated MSW 46 onto high speed conveyor belt 44, or the like such as a moving sidewalk, for example only and not by way of limitation. Conveyor belt 44 may be any useful dimension but Applicant has determined that a conveyor belt 44 that is about forty inches wide and includes projections or paddles on the surface for assisting in the high speed movement of untreated MSW 46 is a useful dimension. Importantly, the initial unloading takes place within an enclosed space such that any and all emissions from the MSW, either treated or untreated, are contained within the enclosure until suitable for release.

At step B, a bag breaking roller 62 breaks up the untreated MSW 46 and disperses the untreated MSW 46 along conveyor belt 44. Once dispersed, untreated MSW 46 at step C passes by a large electro-magnet 64 which collects iron materials away from the untreated MSW 46. Any collected iron material is removed for recycling and not subjected to the rest of the process. At step D lime storage device 66 dispenses lime, or any other pretreatment chemical, on untreated MSW 46. Applicant has determined that the addition of lime to the untreated MSW 46 prior to the introduction of the untreated MSW 46 to process vessel 12 greatly increases the effectiveness of the treatment and reduces the creation of toxic emissions. That is, Applicant has determined that the addition of a pretreatment mineral such as lime, for example only, controls acid within the vessel 12 and limits acid emissions in the recovered vapors and limits acid retained in the end product.

High speed conveyor belt 44 at step F loads untreated MSW 46 into process vessel 12 through open/removed loading door 18 as discussed above. Lbad sensor 30 monitors the loading process and stops the loading once the maximum load capacity of process vessel 12 has been reached. Once process vessel 12 is accurately determined to be fully loaded, by weight or volume as discussed above, loading door 18 is closed and sealed and thereby process vessel 12 is made ready for the addition of heated gas and pressure. Safety lights and horns sound for an appropriate warning period, ten seconds for example, prior to the beginning of the rotation of process vessel 12.

Process vessel 12 is rotated about its longitudinal axis by motors and attachments known in the art and not shown specifically. Any device for rotating the process vessel 12 in a manner useful to the purposes of embodiments of the invention is appropriate and well within ordinary skill levels. Importantly, load sensor 30 determines the proper rotational speed for every batch of untreated MSW 46 loaded into process vessel 12. In this regard, load sensor 30 includes a controller function as well for using the data sensed by load sensor 30 and for controlling the functions of the treatment process in accordance therewith, such as for example only, rotational speed and the introduction of gas to the process vessel 12 and the monitoring of temperature and pressure. Accordingly, load sensor 30 records the impacting vibrations in the form of falling load impact signatures from the falling MSW 46 in the interior treatment space 16. The speed of rotation is increased by the control function of load sensor 30 automatically until the vibrations pass a maximum and begin to decrease. At that point, the speed of rotation is reduced until maximum vibrations are reached again and this is the “maximum speed” of rotation for each particular batch of MSW and is the desired operational speed for effective treatment of the MSW 46. Once the maximum speed of rotation has been determined for each particular batch of untreated MSW 46, steam 40 is introduced to process vessel 12 and pressure is applied in accordance with any of the systems disclosed above. Each batch of MSW being treated is constantly monitored by load density by load sensor 30 and the process vessel 12 rotation speed is automatically increased and decreased during the treatment process accordingly. That is, the load sensor 30 tracks the optimum rotational speed for a batch of MSW undergoing treatment as the MSW 46 change in density. The desired speed is as close to the largest load signal detected by load sensor 30 relative to the best speed for allowing the MSW 46 to fall within process vessel 12 from as close as possible to a vertical position. Any faster rotation effectively stops the circulation of the MSW 46 and the desired inertial grinding effect of the MSW 46 in motion. Likewise, too slow of a rotational speed increases the process time and does not allow for as much surface area contact of the MSW 46 with the steam. According to several embodiments, then, the correct speed of rotation depends on the process dynamics of the MSW 46 within process vessel 12 and is not simply a predetermined operation speed set point. Instead, solid waste treatment apparatus and method 10 responds automatically according to load sensor 30 input to adjust rotation and treatment times for each particular batch of MSW 46. Depending on the implementation, load sensor 30 may be coupled to a separate controller device or the two may be integrated, all as known in the art.

Importantly, at this point all prior art systems begin a tedious and demanding analysis of temperature maximums and minimums and an arbitrary range of time periods in order to guess when a particular batch of untreated MSW 46 may be most likely to be fully treated. In contrast, Applicant's load sensor 30 governs the introduction of steam into the process vessel 12 by sensing the load impact vibrations and ensuring that the amount of steam introduced does not cancel them out by the application of too much upward thrust from the steam. At this point MSW 46 is being rotated in such a manner that it is being lifted and dropped and caused to fall past the incoming steam which, as is known, allows for the de-manufacturing of organics and paper products. Applicant has determined that this dramatically increases the density of the MSW 46 and load sensor 30 tracks the increasing density in the form of falling load impact signatures as discussed above. Maximum load density of each particular batch of MSW 46 is determined at the point that the falling load signatures stabilize. Once load sensor 30 indicates that maximum load density has been achieved for each individual batch of untreated MSW 46, the treatment process is known to be complete with a certainty heretofore impossible to determine. Applicant's solid waste treatment apparatus and method 10 is controlled by load sensor(s) 30 for measuring the impact vibrations for the determination of the best speed of rotation and for indicating when each batch is in fact “done”. Again, each batch is known to be done by the measurement of the maximum load density so that times, temperatures and pressures are essentially irrelevant. Suffice to say, the MSW 46 has been heated to temperatures and pressures that allow for the removal of biohazards and the demanufacturing of the untreated MSW42.

According to one aspect of the invention, a vapor recovery system pump (not shown) applies a partial vacuum to the process vessel 12 once the maximum load density has been reached. This assists in drying the treated MSW 52. Such a pump is connected to steam exhaust line 28 and located just prior to entering vapor recovery tank 68. Further, steam developed from the heated MSW 46 is pulled away through steam exhaust line 28 into vapor recovery tank 68 once steam from steam generation unit 70 is turned off. Vapor recovery tank 68 condenses steam vapors by compressing the hot vapors and forcing them to flow under a sustained liquid level of water in which the vapors rapidly lose heat and return to liquid. The vapor recovery system monitors the vapor pressure within process vessel 12 and at such time as the pressure becomes negative the rotation of the process vessel 12 is stopped and steam exhaust line vent 28 is opened to vapor recovery vessel 68. According to one embodiment, vapor recovery vessel 68 is a magnetic emissions treatment device as disclosed in Applicant's co-pending U.S. patent application Ser. No. 11/443,726 for a molecular arrangement magnetic treatment apparatus and method.

Process vessel 12 is then lowered and adjustable outlets 20 and/or outlets 42 are activated by the introduction of a small amount of gas so as to move the treated MSW 52 to loading door 18. Loading door 18 is then opened or removed and treated MSW 52 is dumped into pit 54 at step G.

From pit 54, treated MSW 52 is moved past secondary magnet 72 at step H by conveyor 44 at step I to a rotational screen device 74 at step J. Treated MSW 52 is passed by radio frequency (RF) can magnet at step K for collection of non-ferrous metals and material that does not pass through screen holes of a desired dimension, such as glass and heavier plastics, are bulk stored at step L in bulk material collector 78. Treated MSW 52 that passes through rotational screen 74 is passed to treated MSW bin 80 at step M. Thereafter, at step N, a conveyor 44 transfers quantities of treated MSW 52 to a mixing tank 82 at step O. Treated MSW 52 in mixing tank 82 is mixed with and treated with mineral supplements such as granite dust in mineral tank 84 at step P and/or nitrate and/or phosphate in mineral tank 86 at step Q. These and other minerals and supplements are used to create a useful end product. The end result of Applicant's method is a manufactured brown loam (MBL) product which Applicant has determined has extraordinary properties and may be used in land reclamation projects, agricultural enhancement projects and the like. Applicant's blending of chemicals and mineral nutrients for a specific PH and nutrient balance, for example only, creates an end product merchantable to agricultural, land recovery or non-food crop industrialized farming operations such as the growing of corn and sugar cane for the production of ethanol fuels. Further, as a result of Applicant's treatment apparatus and method 10 the MBL itself may be used directly in the production and creation of ethanol due in part at least to its non-acid chemistry, heretofore unknown in the art. Needless to say there is a need in the market for the creation of such a useful byproduct of MSW. From mixing tank 82, the MBL is transferred to an outbound bulk loader 88 at step R where the MBL may be bagged or transferred in bulk shipments by conveyor 44 to outbound transport truck 86 at step S.

The description of the present embodiments of the invention has been presented for purposes of illustration, but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention as defined by the following claims.

What is claimed is:

1. A solid waste treatment apparatus including:
a. a process vessel with an exterior and an interior; and
b. outlets in said process vessel for introducing gas into said interior from said exterior through said outlets wherein said outlets are adjustable such that gas may be directed toward a location of the interior of said process vessel.

2. The apparatus of claim 1 further including a load sensor coupled to said process vessel for automatically sensing capacity of said process vessel.

3. A solid waste treatment apparatus including:
a. a double hull process vessel wherein said double hull process vessel includes an exterior vessel and an interior vessel;
b. a space between said exterior vessel and said interior vessel for receiving gas into said exterior vessel; and
c. outlets in said interior vessel such that said gas in said space is introduced to said interior vessel from said exterior vessel through said outlets.

4. The apparatus of claim 3 further including a load sensor coupled to said double hull process vessel for automatically sensing capacity of said double hull process vessel.

5. The apparatus of claim 4 wherein said load sensor senses impacting vibrations of solid waste within said double hull process vessel as said double hull process vessel is rotated.

6. The apparatus of claim 4 wherein said double hull process vessel is rotated and said load sensor controls how fast said double hull process vessel is rotated.

7. The apparatus of claim 4 wherein said load sensor controls how much gas is introduced into said space.

8. The apparatus of claim 4 wherein said load sensor senses falling load impact signatures when said double hull process vessel is rotated.

9. The apparatus of claim 4 wherein said outlets are angled such that gas is introduced into said interior vessel and is directed toward a location of the interior vessel.

10. A solid waste treatment apparatus including:
a a double hull process vessel with a loading door wherein said double hull process vessel includes an exterior vessel and an interior vessel;
b. a space between said exterior vessel and said interior vessel for receiving steam into said exterior vessel;
c. outlets in said interior vessel such that said steam in said space is introduced to said interior vessel from said exterior vessel through said outlets wherein said outlets are angled such that steam is introduced into said interior; and
d. a load sensor coupled to said double hull process vessel for automatically sensing capacity of said double hull process vessel and wherein said load sensor senses impacting vibrations of said solid waste within said double hull process vessel as said double hull process vessel is rotated.

11. The apparatus of claim 10 wherein said load sensor controls how fast said double hull process vessel is rotated.

12. The apparatus of claim 10 wherein said load sensor controls how much steam is introduced into said space.

13. The apparatus of claim 10 wherein said load sensor senses falling load impact signatures as said double hull process vessel is rotated.

14. The apparatus of claim 10 further including a lift for raising and lowering said double hull process vessel.

15. The apparatus of claim 10 further including a high speed loader for loading solid waste into said apparatus at high speed.

16. The apparatus of claim 10 further including a magnetic emission treatment device for treating emissions from said double hull process vessel.

17. The apparatus of claim 10 further including a closeable floor pit into which treated solid waste is deposited after treatment in said double hull process vessel.

18. A solid waste treatment method including:
a providing a double hull process vessel with a loading door wherein said double hull process vessel includes an exterior vessel and an interior vessel wherein a space is maintained between said exterior vessel and said interior vessel for receiving steam into said exterior vessel and wherein outlets are provided in said interior vessel such that steam introduced into said space is introduced to said interior vessel from said exterior vessel through said outlets toward a location and wherein a load sensor is coupled to said double hull process vessel for automatically sensing capacity of said double hull process vessel as said double hull process vessel is loaded with solid waste and wherein said load sensor senses impacting vibrations of said solid waste within said double hull process vessel as said double hull process vessel is rotated;
b. loading solid waste into said double hull process vessel until said load sensor indicates capacity has been reached;
c. rotating said double hull process vessel and adding steam until said load sensor indicates that a maximum load density has been reached; and
d. emptying said double hull process vessel.

19. The method of claim 18 wherein said load sensor senses falling load impact signatures as said double hull process vessel is rotated.

20. The method of claim 18 further including a lift for raising and lowering said double hull process vessel.

21. The method of claim 18 further including treating emissions from said double hull process vessel with a magnetic emission treatment device.

22. The method of claim 18 further including providing a closeable floor pit into which treated solid waste is deposited after treatment in said double hull process vessel.

23. The method of claim 18 wherein said outlets are adjustable.

24. The method of claim 18 further including adding material from a group comprising chemicals and minerals to said solid waste and using treated solid waste in the creation of ethanol.

25. A method of treating solid waste comprising:
a. loading the solid waste into an interior of a process vessel;
b. rotating the process vessel; and
c. introducing gas from an exterior of the process vessel into the interior in a direction toward a location of the interior of the process vessel through directionally adjustable outlets.

26. The method of claim 25 further including adding material from a group comprising chemicals and minerals to said solid waste and using treated solid waste in the creation of ethanol.

27. A method of treating solid waste comprising:
a. loading the solid waste into an interior vessel of a double hull process vessel until a load sensor indicates a predetermined capacity has been reached, the double hull process vessel also having an exterior vessel, wherein a space is maintained between the interior vessel and the exterior vessel;
b. rotating said double hull process vessel;
c. adding steam into the interior vessel from the exterior vessel through outlets of the interior vessel;
d. sensing impact vibrations of the double hull process vessel in order to determine that a predetermined load density of the solid waste has been reached;
e. stopping the addition of the steam into the interior vessel; and
f. emptying said double hull process vessel.

28. The method of claim 27 further including adding material from a group comprising chemicals and minerals to said solid waste and using treated solid waste in the creation of ethanol.
